(19) United States
(12) Patent Application Publication
(10) Pub. No.: US 2011/0045187 A1
(43) Pub. Date: Feb. 24, 2011

(54) A Pad Manufacturing Process

(75) Inventor: Edward McCloskey, County Louth (IE)

Correspondence Address: CHOATE, HALL & STEWART LLP, TWO INTERNATIONAL PLACE, BOSTON, MA, 02110, US

(73) Assignee: Edmak Limited, County Louth (IE)

(21) Appl. No.: 12/294,517

(22) PCT Filed: Mar. 27, 2007
(86) PCT No.: PCT/EP2007/052945

§ 371 Date: Nov. 9, 2010

(30) Foreign Application Priority Data
Mar. 27, 2006 (IE) S2006/0233

(51) Int. Cl. D06B 5/24; B05D 1/00; B05C 9/00

(52) U.S. Cl. 427/294; 118/50

(57) ABSTRACT

In a process for manufacturing wet wipes and the like products dry cotton pads are formed (1) and delivered to a vacuum chamber (2). Within the vacuum chamber (2) the dry pads are impregnated with liquid under vacuum conditions to evenly distribute liquid throughout the dry pads to form wet pads. The wet pads are then delivered to a packing station (4). The wet pads may be briefly separated at a parting station (5), by air knives for example, prior to delivery to the packing station (4).

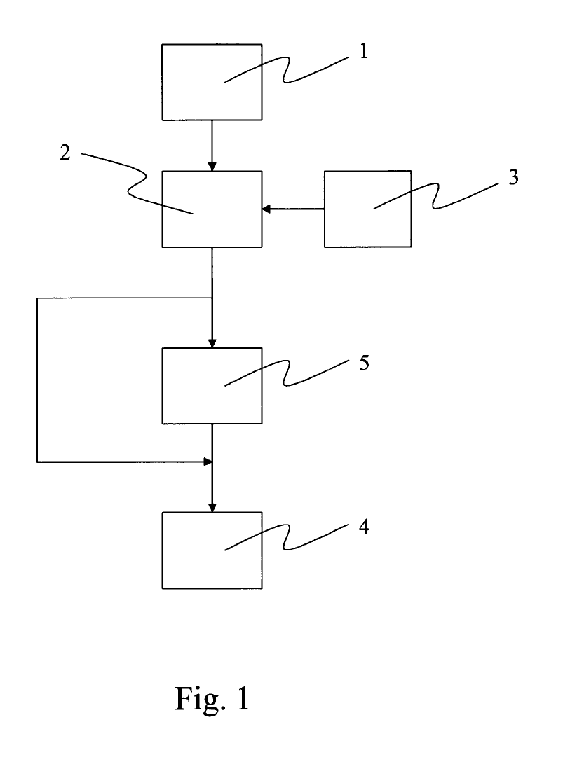

### FIELD OF THE INVENTION

This invention relates to a process and apparatus for manufacturing pads or wipes, and in particular pre-moistened pads.

### BACKGROUND OF THE INVENTION

Pre-moistened wipes for use as baby wipes, cosmetic removal pads, cleaning wipes and the like are now widely used. There has been huge growth in the usage of such products due to their convenience. They typically comprise an artificial fibre substrate or composite substrate typically of 30-60 gsm impregnated by a liquid. Various liquids are used depending on the application for which the pads are provided. A cleansing liquid may be provided for cosmetic removal or for cleaning surfaces such as kitchen worktops or for cleaning babies for example. The liquid may include various lotions, perfumes, medications, disinfectants, preservatives and the like depending on the intended usage of the wipe.

For cosmetic and baby care applications particularly many users would prefer to use relatively thick (typically 100-250 gsm) very soft cotton wool pads instead. However this product is generally sold in dry form due to the difficulty of wetting the cotton wool pad consistently. Cotton wool adheres to itself when wet, causing usage problems and difficulty for the user in identifying and /or separating one pad from the next when they are provided in a stack. Also, due to the exceptionally absorbent nature of cotton wool there are difficulties in consistently and evenly distributing the liquid throughout the pad material—especially at the typically desired wetting ratio of between 3:1 and 5:1. Typically a preservative is included in the liquid and it is especially critical to evenly distribute the preservative throughout the material. To achieve this spraying or syringing methods are not reliable.

The present invention is directed towards overcoming these problems to consistent and accurate wetting of thick cotton pads, whether individual or linked together.

### SUMMARY OF THE INVENTION

According to the invention there is provided a pad manufacturing process for manufacturing a liquid impregnated pad, the process including:
delivering the dry pad to a vacuum chamber,
introducing a desired quantity of liquid into the vacuum chamber for impregnating the dry pad with the liquid under vacuum within the vacuum chamber for forming a wet pad, and
discharging the wet pad from the vacuum chamber.

In one embodiment of the invention, the process includes:
delivering the dry pad to a vacuum chamber,
drawing a vacuum in the vacuum chamber,
introducing a desired quantity of liquid to the vacuum chamber for impregnating the pad with the liquid under a vacuum in the vacuum chamber for forming a wet pad,
releasing the vacuum,
compressing the pad,
releasing the compression, and
discharging the wet pad from the vacuum chamber.

Advantageously according to the process of the invention a more even and complete distribution of the liquid throughout the pad material can be achieved by wetting the dry pad under a vacuum. Instead of a single dry pad a stack or roll comprising a plurality of dry pads may be delivered to the vacuum chamber.

In another embodiment the dry pads or stack of dry pads is loaded into the vacuum chamber which is then closed, the chamber is then filled with an ample amount of liquid with a vacuum applied to the chamber, the vacuum is then released, and the pad or stack of pads are compressed to achieve a desired wetting ratio, the chamber is then drained and opened and the wet stack is removed from the chamber. Some of these actions can happen simultaneously.

In another embodiment the pad is compressed within the vacuum chamber. The compressing can be carried out either before or after the vacuum is released.

In a further embodiment the pad is compressed whilst under vacuum within the vacuum chamber.

In one embodiment the process includes compressing the pad after impregnating the pad with liquid.

In another embodiment the process includes the step of compressing the dry pad prior to impregnating the pad with liquid.

In another embodiment the process includes compressing the dry pad upstream of the vacuum chamber.

Preferably the process includes the step of compressing the dry pad to the shape and size corresponding to the wetting ratio desired.

In a preferred embodiment the desired wetting ratio is in the order of 3.5:1 of liquid to dry pad by weight. The wetting ratio may be in the range 3:1 to 5:1.

In a further embodiment the process includes the step of forming a stack or roll comprising a plurality of dry pads prior to delivering said stack or roll to the vacuum chamber for impregnating said stack or roll with the liquid.

In a preferred embodiment said stack or roll comprises a continuous web of material with spaced-apart transverse perforated tear lines subdividing the web into separate interlinked tear-away pads (see, for example, our previous patent application No. PCT/IE2004/000104).

In a particularly preferred embodiment a stack of pads interconnected by perforated tear lines is provided with the pads arranged in a zig-zag formation in the stack.

In another embodiment the process includes the step of packing a plurality of wet pads in a package.

In another embodiment the process includes the step of briefly physically parting the wet pads in a stack of wet pads prior to packing the stack of wet pads. This advantageously will minimise any mild adhesion between the individual wet pads in the stack.

Conveniently the process may include the step of briefly parting the wet pads using one or more air-knives. Any other suitable temporary separating method could be used.

In a particularly preferred embodiment the pads are formed of cotton wool material. Preferably the cotton wool material has a weight in the range 100-250 gsm.

The liquid used to impregnate the dry pads will be varied according to the particular application. It may simply be water or may for example include a cleansing agent, medication, disinfectant, or any other desired lotion, additive or the like. The liquid may also include a preservative for many applications.

In another aspect the invention provides apparatus for carrying out the process of the invention, including a vacuum chamber with means for generating a partial vacuum within the vacuum chamber, means for delivering one or more dry pads to the vacuum chamber, means for introducing liquid to the vacuum chamber, and means for discharging a wet pad or pads from the vacuum chamber.

In a preferred embodiment the apparatus includes means for introducing liquid to the vacuum chamber in a controlled manner.

In another embodiment the apparatus has means for delivering pads from the vacuum chamber on to the air knives and a packing station.

In another embodiment the apparatus includes means for compressing the pad or pads prior to delivering the pad or pads to the vacuum chamber or within the vacuum chamber.

In another embodiment the apparatus includes means for packaging the wet pads downstream of the vacuum chamber.

In a further embodiment the apparatus includes means for briefly separating wet pads in a stack of wet pads prior to packaging the wet pads. Air knives may be provided for briefly separating the wet pads.

In another embodiment the apparatus includes means for forming a dry pad upstream of the vacuum chamber.

### BRIEF DESCRIPTION OF THE DRAWINGS

The invention will be more clearly understood by the following description of some embodiments thereof, given by way of example only, with reference to the accompanying drawing which is a schematic illustration of a pad manufacturing process according to the invention.

### DETAILED DESCRIPTION OF PREFERRED EMBODIMENTS

Referring to the drawing, dry cotton wool pads are formed at a pad forming station 1. Preferably the pads will have a weight in the range 100-250 gsm. Each pad may be individually delivered to a vacuum chamber 2 or a number of the pads may be arranged in a stack such as for example a zig-zag folded stack of pads interconnected by perforated tear lines.

Within the vacuum chamber 2 the pads are subjected to a partial or full vacuum. The desired volume of liquid for impregnation of the pad or pads is introduced to the vacuum chamber from a liquid supply source 3 and will rapidly distribute itself throughout the pad material consistently and evenly. There should be enough liquid to over saturate the pad or pads.

After releasing the vacuum the pads are compressed to the shape and size corresponding to the desired wetting ratio, which will typically be 3.5:1 of liquid to dry pad by weight.

After releasing the compression draining away excess liquid and opening the vacuum chamber the pad or pads which are now wet pads are delivered to a packing station 4. At the packing station 4 either individual pads or a plurality of the pads are packed in a liquid tight package. If desired prior to packaging a number of pads together any mild adhesion between individual wet pads may be minimised by physically parting them briefly using one or more air-knives or some other method at a parting station 5 located between the vacuum chamber 2 and the packing station 4.

In an alternative arrangement the pad or pads may be compressed to the shape and size corresponding to the wetting ratio desired prior to delivery to the vacuum chamber 2.

It will be appreciated that the invention provides a process and apparatus for manufacturing wet pads and stacks of wet pads of relatively thick cotton wool material. However, it may also have application to wetting substrates of other materials also in ensuring an even and consistent distribution of the liquid throughout the pad.

The invention is not limited to the embodiments hereinbefore described which may be varied in both construction and detail within the scope of the appended claims.

1. A pad manufacturing process for manufacturing a liquid impregnated pad, the process including:
delivering a dry pad to a vacuum chamber,
introducing a desired quantity of liquid into the vacuum chamber for impregnating the dry pad with the liquid under vacuum within the vacuum chamber for forming a wet pad, and
discharging the wet pad from the vacuum chamber

2. A process as claimed in claim 1, the process including:
delivering the dry pad to a vacuum chamber,
drawing a vacuum in the vacuum chamber,
introducing a desired quantity of liquid to the vacuum chamber for impregnating the pad with the liquid under a vacuum in the vacuum chamber for forming a wet pad,
releasing the vacuum,
compressing the pad,
releasing the compression, and
discharging the wet pad from the vacuum chamber

3. A process as claimed in claim 2 including compressing the pad within the vacuum chamber.

4. A process as claimed in claim 3 wherein the process includes compressing the pad whilst under vacuum within the vacuum chamber.

5. A process as claimed in claim 2 wherein the process includes compressing the pad after impregnating the pad with liquid.

6. A process as claimed in claim 2 wherein the process includes the step of compressing the dry pad prior to impregnating the pad with liquid.

7. A process as claimed in claim 6 including compressing the dry pad upstream of the vacuum chamber.

8. A process as claimed in claim 1 wherein the process includes the step of compressing the pad to a shape and size corresponding to a desired wetting ratio.

9. A process as claimed in claim 1 wherein the pad is impregnated with liquid to a desired wetting ratio in the range of 3:1 to 5: 1 of liquid to dry pad by weight.

10. A process as claimed in claim 9 wherein the pad is impregnated to a desired wetting ratio of 3.5:1.

11. A process as claimed in claim 1 wherein the process includes the step of forming a stack or roll of dry pads comprising a plurality of dry pads prior to delivering said stack or roll to the vacuum chamber for impregnating said stack or roll with the liquid.

12. A process as claimed in claim 11 wherein the stack or roll comprises a continuous web of material with spaced-apart transverse perforated tear lines subdividing the web into separate interlinked tear-away pads.

13. A process as claimed in claim 12 wherein the pads are arranged in a zig-zag formation in the stack.

14. A process as claimed in claim 11 wherein the process includes the step of briefly physically parting the wet pads in a stack of wet pads prior to packing the stack of wet pads.

15. A process as claimed in claim 14 wherein the process includes the step of briefly parting the wet pads using one or more air-knives.

16. A process as claimed in claim 1 wherein the pads are formed of cotton wool material having a weight in the range 100-250 gsm.

17. Apparatus for carrying out the process as claimed in claim 1 including a vacuum chamber with means for generating a partial vacuum within the vacuum chamber, means for delivering one or more dry pads to the vacuum chamber, means for introducing liquid to the vacuum chamber, and means for discharging a wet pad or pads from the vacuum chamber.

18. Apparatus as claimed in claim 17 wherein the apparatus includes means for introducing liquid to the vacuum chamber in a controlled manner.

19. Apparatus as claimed in claim 17 wherein the apparatus includes means for compressing the pad or pads prior to delivering the pad or pads to the vacuum chamber or within the vacuum chamber.

20. Apparatus as claimed in claim 17 wherein the apparatus includes means for briefly separating wet pads in a stack of wet pads prior to packaging the wet pads.
